(19) United States
(12) Patent Application Publication
(10) Pub. No.: US 2025/0289253 A1
(43) Pub. Date: Sep. 18, 2025

(54) PRINTING APPARATUS

(71) Applicant: SEIKO EPSON CORPORATION, Tokyo (JP)

(72) Inventors: Yuki ONO, MATSUMOTO-SHI (JP); Kenji OTOKITA, YAMAGATA-MURA (JP); Yujiro NOMURA, SHIOJIRI-SHI (JP)

(21) Appl. No.: 19/077,659

(22) Filed: Mar. 12, 2025

(30) Foreign Application Priority Data
Mar. 15, 2024 (JP) 2024-040895

(51) Int. Cl. B41J 29/377; B41J 11/00; B41J 13/22

(52) U.S. Cl. CPC B41J 29/377; B41J 11/00214; B41J 13/223

(57) ABSTRACT

A printing apparatus includes a supporting drum configured to support a medium, a printing unit configured to discharge ultraviolet-light curable-type ink, an emitting unit opposed to the supporting drum and configured to emit ultraviolet light, and an air blowing unit configured to deliver air to the supporting drum. The supporting drum includes a rotating body and a sealing member attached to the rotating body. The rotating body includes a shaft portion, a peripheral-surface portion around which the medium is looped, and a coupling portion configured to couple the shaft portion and the peripheral-surface portion. The peripheral-surface portion defines a first opening and a second opening that open in a shaft direction, the sealing member is attached to the rotating body so as to close the second opening, and the air blowing unit delivers air to an inside of the rotating body from the first opening toward the second opening.

The present application is based on, and claims priority from JP Application Serial Number 2024-040895, filed Mar. 15, 2024, the disclosure of which is hereby incorporated by reference herein in its entirety.

### BACKGROUND

### 1. Technical Field

The present disclosure relates to a printing apparatus.

### 2. Related Art

JP-A-2014-181083 describes a printing apparatus including: a supporting drum configured to rotate in a state where a medium is looped therearound; a printing unit configured to discharge a liquid to the medium looped around the supporting drum; an emitting unit configured to emit ultraviolet light to the liquid discharged to the medium; and an air blowing unit configured to deliver air to the inside of the supporting drum. The printing unit discharges, to the medium, curable-type ink cured with ultraviolet light. When the emitting unit emits ultraviolet light to the liquid, the heat of reaction occurs from the liquid. This makes the supporting drum more likely to have a high temperatures due to this heat of reaction. The air blowing unit delivers air to the inside of the supporting drum, thereby cooling the supporting drum.

In a case of the printing apparatus described in JP-A-2014-181083, the air delivered by the air blowing unit passes through the supporting drum. Thus, there is a possibility that the supporting drum is not sufficiently cooled, and the supporting drum has a high temperature.

### SUMMARY

A printing apparatus that solves the problem described above includes a supporting drum configured to support a medium looped therearound, a printing unit disposed so as to be opposed to the supporting drum and configured to discharge ultraviolet-light curable-type ink to the medium supported by the supporting drum, an emitting unit disposed so as to be opposed to the supporting drum and configured to emit ultraviolet light to the ink discharged to the medium, and an air blowing unit configured to deliver air to the supporting drum, in which the supporting drum includes a rotating body configured to rotate and also includes a sealing member attached to the rotating body, the rotating body includes a shaft portion, a peripheral-surface portion around which the medium is looped, and a coupling portion configured to couple the shaft portion and the peripheral-surface portion, the peripheral-surface portion defines a first opening and a second opening that open in a shaft direction, the sealing member is attached to the rotating body so as to close the second opening, and the air blowing unit delivers air to an inside of the rotating body from the first opening toward the second opening.

### BRIEF DESCRIPTION OF THE DRAWINGS

FIG. 1 is a side view illustrating one embodiment of a printing apparatus.

FIG. 2 is a perspective view illustrating a supporting drum.

FIG. 3 is a perspective view illustrating the supporting drum as viewed from an angle differing from FIG. 2.

FIG. 4 is an exploded perspective view illustrating the supporting drum.

FIG. 5 is a perspective view illustrating a rotating body.

FIG. 6 is a graph showing an increase in temperatures of the supporting drum.

FIG. 7 is a cross-sectional view illustrating the printing apparatus.

FIG. 8 is a side view illustrating a modification example of the printing apparatus.

FIG. 9 is a cross-sectional view illustrating the modification example illustrated in FIG. 8.

FIG. 10 is a side view illustrating another modification example differing from FIGS. 8 and 9.

FIG. 11 is a cross-sectional view illustrating the modification example illustrated in FIG. 10.

FIG. 12 is a plan view illustrating a modification example of a sealing member.

### DESCRIPTION OF EMBODIMENTS

Below, one embodiment of a printing apparatus will be described with reference to the drawings. The printing apparatus is, for example, an ink jet-type printer configured to discharge ultraviolet-light curable-type ink to a medium such as a sheet or fabric or a film to print an image of characters, a photo, or the like.

### Printing Apparatus

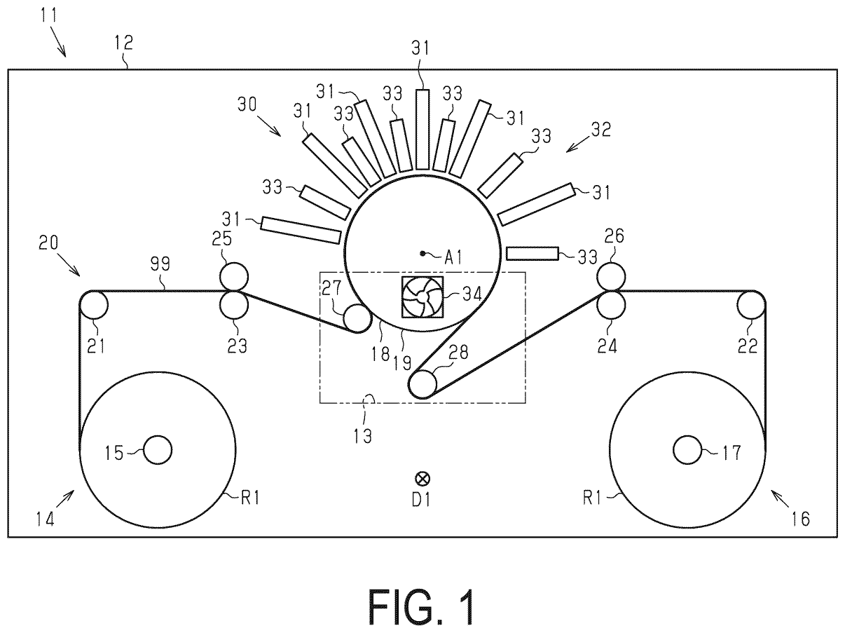

As illustrated in FIG. 1, a printing apparatus 11 includes a housing 12. An inlet opening 13 is opened in the housing 12. The inlet opening 13 is an opening used to taking in air from the outside. The outside air is taken into the inside of the housing 12 through the inlet opening 13, which facilitates cooling the inside of the housing 12.

The printing apparatus 11 includes a feeding portion 14. The feeding portion 14 is accommodated in the housing 12. The feeding portion 14 is configured to feed a medium 99. Specifically, the feeding portion 14 feeds a long medium 99 from a roll body R1. The roll body R1 is an item around which the medium 99 is looped. The feeding portion 14 is configured to retain the roll body R1. The feeding portion 14 rotatably retains the roll body R1.

The feeding portion 14 includes a feeding shaft 15. With the feeding shaft 15 being inserted into the roll body R1, the feeding portion 14 rotatably retains the roll body R1. The feeding shaft 15 may be configured to rotate together with the roll body R1, or may be configured so as not to be able to rotate. The feeding shaft 15 may be configured to rotate with power of a motor (not illustrated), or may be configured to rotate in a following manner in association with the medium 99 being pulled.

The printing apparatus 11 includes a winding unit 16. The winding unit 16 is accommodated in the housing 12. The winding unit 16 is configured to wind the medium 99. The winding unit 16 winds the medium 99 to form the roll body R1. The winding unit 16 is configured to retain the roll body R1. The winding unit 16 rotatably retains the roll body R1.

The winding unit 16 includes a winding shaft 17. The winding shaft 17 is configured to rotate together with the roll body R1. The winding shaft 17 is configured to rotate with power of a motor (not illustrated). With the rotation of the winding shaft 17, the winding unit 16 winds the medium 99.

The printing apparatus 11 includes a supporting drum 18. The supporting drum 18 is accommodated in the housing 12. The supporting drum 18 is configured to support the medium 99. The supporting drum 18 supports the medium 99 during a process from the medium 99 being fed from the feeding portion 14 to the medium 99 being wound by the winding unit 16.

The supporting drum 18 includes a peripheral surface 19. The medium 99 is looped around the supporting drum 18 along the peripheral surface 19. The supporting drum 18 supports the medium 99 that is looped around it. On the supporting drum 18, an image is printed on the medium 99. The supporting drum 18 has a cylindrical shape.

The supporting drum 18 is configured to rotate. The supporting drum 18 may be configured to rotate with power of a motor (not illustrated), or may be configured to rotate in a following manner in association with the medium 99 being transported. In one example, the supporting drum 18 is disposed so as to overlap with the inlet opening 13 when viewed from a shaft direction D1. Specifically, a portion of the supporting drum 18 overlaps with the inlet opening 13 when viewed from the shaft direction D1. The entire supporting drum 18 may overlap with the inlet opening 13 or the supporting drum 18 may not overlap with the inlet opening 13, when viewed from the shaft direction D1. The shaft direction DI is a direction in which a rotary axis A1 of the supporting drum 18 extends. The rotary axis A1 is an imaginary axis. The supporting drum 18 will be described in detail later.

The printing apparatus 11 includes a transport unit 20. The transport unit 20 is accommodated in the housing 12. The transport unit 20 is configured to transport the medium 99. The transport unit 20 transports the medium 99 from the feeding portion 14 toward the winding unit 16. Specifically, the transport unit 20 transports the medium 99 from the feeding portion 14 toward the winding unit 16 so as to pass through the supporting drum 18.

The transport unit 20 includes one or more guide rollers. The transport unit 20 includes a first guide roller 21 and a second guide roller 22, for example. The guide rollers are rollers configured to guide the medium 99. The medium 99 is looped around the guide rollers. The first guide roller 21 comes into contact with a portion of the medium 99 on which printing is not yet performed. The first guide roller 21 guides the medium 99 from the feeding portion 14 toward the supporting drum 18. The second guide roller 22 comes into contact with a portion of the medium 99 on which printing has already been performed. The second guide roller 22 guides the medium 99 from the supporting drum 18 toward the winding unit 16.

The transport unit 20 includes one or more transport rollers. The transport unit 20 includes a first transport roller 23 and a second transport roller 24, for example. The transport roller is a roller configured to transport the medium 99. The transport roller rotates with power of a motor (not illustrated). The first transport roller 23 comes into contact with a portion of the medium 99 on which printing is not yet performed. The first transport roller 23 transports the medium 99 from the feeding portion 14 toward the supporting drum 18. The second transport roller 24 comes into contact with a portion of the medium 99 on which printing has already been performed. The second transport roller 24 transports the medium 99 from the supporting drum 18 toward the winding unit 16.

The transport unit 20 includes one or more driven rollers. The transport unit 20 includes a first driven roller 25 and a second driven roller 26, for example. The driven roller is a roller that is opposed to the transport roller. The first driven roller 25 is opposed to the first transport roller 23. The first driven roller 25 presses the medium 99 against the first transport roller 23. This enables the first transport roller 23 to easily transport the medium 99. The second driven roller 26 is opposed to the second transport roller 24. The second driven roller 26 presses the medium 99 against the second transport roller 24. This enables the second transport roller 24 to easily transport the medium 99.

The transport unit 20 includes one or more supporting rollers. The transport unit 20 includes a first supporting roller 27 and a second supporting roller 28, for example. The supporting rollers are rollers used to loop the medium 99 around the supporting drum 18. The supporting rollers guide the medium 99 such that the medium 99 is looped around the supporting drum 18. The first supporting roller 27 comes into contact with a portion of the medium 99 on which printing is not yet performed. The first supporting roller 27 comes into contact with a portion of the medium 99 immediately before being looped around the supporting drum 18. The second supporting roller 28 comes into contact with a portion of the medium 99 on which printing has already been performed. The second supporting roller 28 comes into contact with a portion of the medium 99 immediately after passing through the supporting drum 18. In one example, the first supporting roller 27 and the second supporting roller 28 are disposed lower than the rotary axis A1 of the supporting drum 18. With this configuration, the medium 99 is looped around the supporting drum 18 so as to have an upwardly convex shape when viewed from the shaft direction D1.

The printing apparatus 11 includes a printing unit 30. The printing unit 30 is accommodated in the housing 12. The printing unit 30 is configured to discharge ink to the medium 99. The printing unit 30 discharges ink to the medium 99, thereby printing an image on the medium 99. The printing unit 30 is opposed to the supporting drum 18. The printing unit 30 discharges ink to the medium 99 supported by the supporting drum 18.

The printing unit 30 includes one or more discharging units 31. In one example, the printing unit 30 includes six discharging units 31. The discharging unit 31 includes a line head that makes it possible to simultaneously discharge ink over the entire width of the medium 99. The six discharging units 31 are opposed to the supporting drum 18. The six discharging units 31 are arranged along the peripheral surface 19. The six discharging units 31 are configured to discharge ink of different colors, for example. The printing unit 30 sequentially discharges ink of different colors to the medium 99, for example.

The printing apparatus 11 includes an emitting unit 32. The emitting unit 32 is accommodated in the housing 12. The emitting unit 32 is configured to emit ultraviolet light to the medium 99. The emitting unit 32 is opposed to the supporting drum 18. The emitting unit 32 emits ultraviolet light to the medium 99 supported by the supporting drum 18. The emitting unit 32 emits ultraviolet light to the medium 99, thereby curing the ink discharged on the medium 99. This makes it possible to fix the ink on the medium 99.

The emitting unit 32 includes one or more emitting sections 33. In one example, the emitting unit 32 includes six emitting sections 33. The emitting sections 33 are configured to be able to emit ultraviolet light over the entire width of the medium 99. The six emitting sections 33 are opposed to the supporting drum 18. The six emitting sections 33 are arranged along the peripheral surface 19. The six emitting sections 33 are arranged alternately with the six discharging units 31, for example. The emitting unit 32 emits ultraviolet light every time ink is discharged to the medium 99, for example. The six emitting sections 33 may be configured so as to differently emit ultraviolet light having different intensities.

The printing apparatus 11 includes an air blowing unit 34. The air blowing unit 34 is accommodated in the housing 12. The air blowing unit 34 is configured to deliver air to the supporting drum 18. In one example, the air blowing unit 34 delivers air toward the supporting drum 18 in a shaft direction D1. The air blowing unit 34 may deliver the air existing within the housing 12, to the supporting drum 18, or may deliver air existing outside of the housing 12 to the supporting drum 18. The air blowing unit 34 delivers, to the supporting drum 18, outside air taken in through the inlet opening 13, for example. The air blowing unit 34 is a fan, for example. The supporting drum 18 tends to have a high temperature due to the heat of reaction occurring when ink is cured. The increase in the temperature of the supporting drum 18 leads to a possibility of affecting the printing quality. For example, when the temperature of the supporting drum 18 increases, ink may smear or the supporting drum 18 may be distorted. By delivering the air to the supporting drum 18, the air blowing unit 34 cools the supporting drum 18.

The air blowing unit 34 may be disposed so as to overlap with the inlet opening 13 when viewed from the shaft direction D1. In this case, the air blowing unit 34 easily delivers, to the supporting drum 18, the outside air taken in from the inlet opening 13. The air blowing unit 34 may be disposed so as to overlap with the supporting drum 18 when viewed from the shaft direction D1. In this case, the air blowing unit 34 easily delivers air to the supporting drum 18. In one example, the air blowing unit 34 is disposed so as to overlap with the supporting drum 18 when viewed from the shaft direction D1. The air blowing unit 34 is disposed lower than the rotary axis A1 of the supporting drum 18.

### Supporting Drum

Next, the supporting drum 18 will be described in detail.

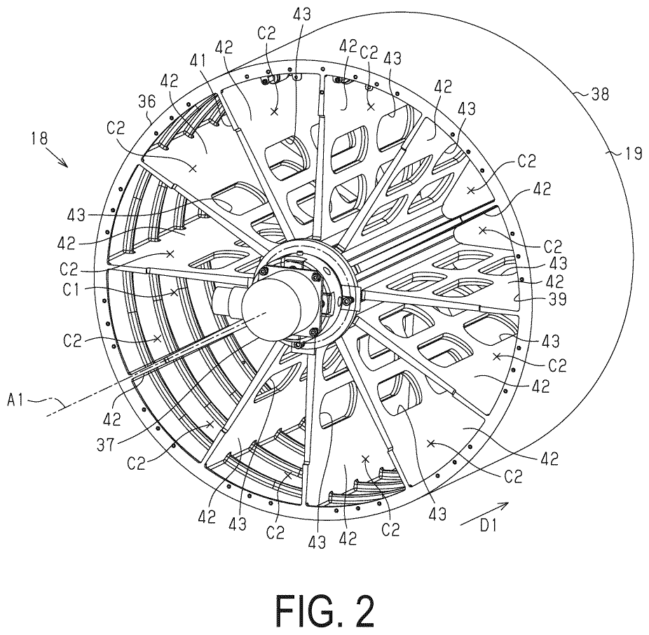

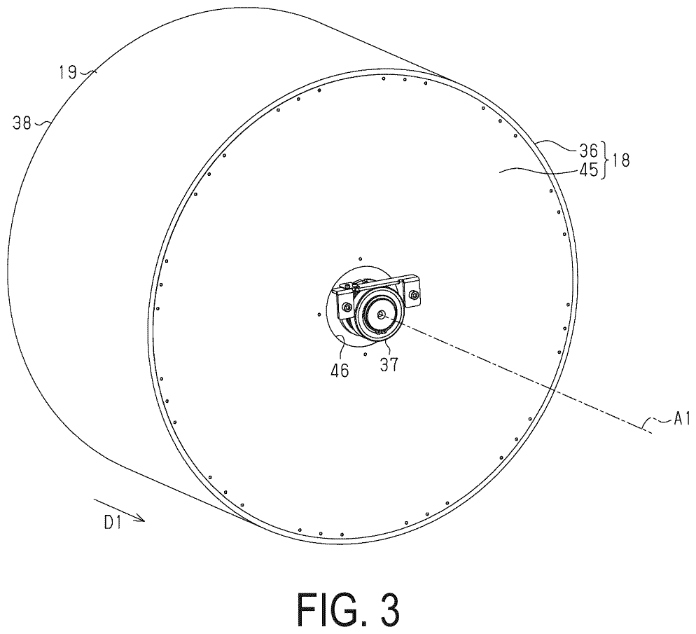

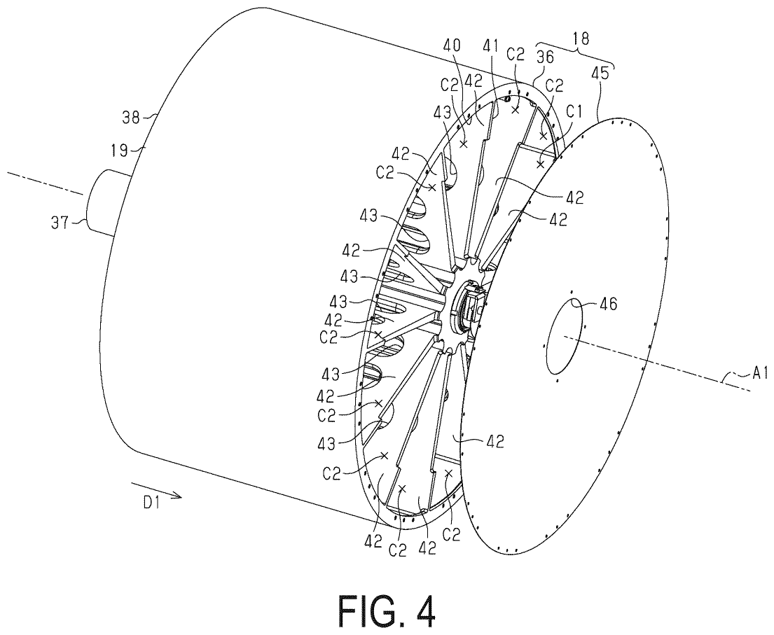

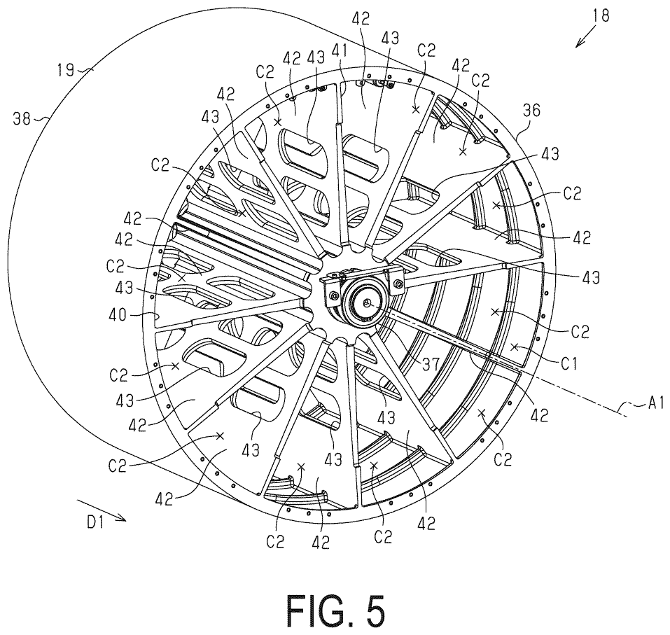

The supporting drum 18 includes a rotating body 36 as illustrated in FIGS. 2, 3, 4, and 5. The rotating body 36 supports the medium 99. The medium 99 is looped over the rotating body 36. The rotating body 36 is configured to rotate. The rotating body 36 defines an internal space C1. As the air blowing unit 34 delivers air to the internal space C1, the rotating body 36 is cooled.

The rotating body 36 includes a shaft portion 37. The shaft portion 37 is a portion serving as the center of rotation of the rotating body 36. The rotary axis A1 penetrates through the shaft portion 37.

The rotating body 36 includes a peripheral-surface portion 38. The peripheral-surface portion 38 is a portion that constitutes the peripheral surface 19. The peripheral-surface portion 38 is disposed so as to surround the shaft portion 37. The peripheral-surface portion 38 comes into contact with the medium 99. The medium 99 is looped over the peripheral-surface portion 38.

The peripheral-surface portion 38 defines a first opening 39 and a second opening 40. The first opening 39 and the second opening 40 are openings that communicate with the internal space C1. The first opening 39 and the second opening 40 are opened in the rotating body 36 and in the shaft direction D1. The first opening 39 is an opening that is opposed to the air blowing unit 34. Air is delivered from the air blowing unit 34 through the first opening 39 to the internal space C1. The second opening 40 is an opening opposite from the first opening 39. In the supporting drum 18, the air blowing unit 34 delivers air from the first opening 39 toward the second opening 40 to the inside of the rotating body 36.

The rotating body 36 includes a coupling portion 41. The coupling portion 41 is a portion configured to couple the shaft portion 37 and the peripheral-surface portion 38. As the coupling portion 41 couples the shaft portion 37 and the peripheral-surface portion 38, the shaft portion 37 and the peripheral-surface portion 38 integrally rotate.

The coupling portion 41 includes a plurality of ribs 42. In one example, the coupling portion 41 includes 12 ribs 42. The ribs 42 extend from the shaft portion 37 toward the peripheral-surface portion 38. The plurality of ribs 42 extend radially from the shaft portion 37 when viewed from the shaft direction D1. The plurality of ribs 42 extend from the shaft portion 37 at an equal angle, for example. The ribs 42 divide the internal space C1 into a plurality of separated spaces C2. In one example, 12 ribs 42 divide the internal space C1 into 12 pieces of separated spaces C2.

One or more through holes 43 are opened in the rib 42. In one example, four through holes 43 are opened in the rib 42. The through hole 43 causes adjacent separated spaces C2 to communicate with each other. Through the through holes 43, air is enabled to flow in between the adjacent separated spaces C2. This enables the air delivered by the air blowing unit 34 to flow from one separated space C2 to another separated space C2. Thus, it is possible to improve the cooling efficiency of the supporting drum 18.

The supporting drum 18 includes a sealing member 45. The sealing member 45 is attached to the rotating body 36. The sealing member 45 is attached to the rotating body 36 so as to close the second opening 40. The sealing member 45 is comprising of a round plate, for example. An insertion opening 46 is opened in the sealing member 45. The shaft portion 37 is inserted into the insertion opening 46.

As the sealing member 45 closes the second opening 40, air does not flow out from the internal space C1 through the second opening 40. In the internal space C1, air flows in and flows out through the first opening 39. Thus, air delivered from the air blowing unit 34 through the first opening 39 stays within the internal space C1. This makes it possible to improve the cooling efficiency of the supporting drum 18, as compared with a case where the air flowing in from the first opening 39 flows out from the second opening 40.

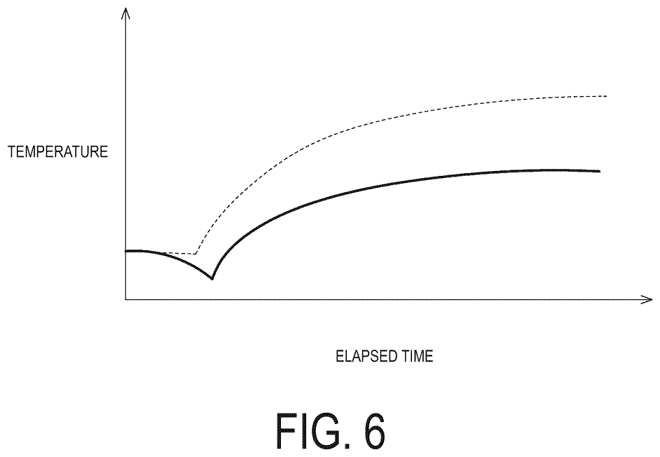

As illustrated in FIG. 6, as the sealing member 45 closes the second opening 40, the temperature of the supporting drum 18 is less likely to increase, as compared with the supporting drum 18 that does not include the sealing member 45. The graph illustrated by the solid line in FIG. 6 indicates a change in temperatures of the supporting drum 18 that includes the sealing member 45. The graph illustrated by the dashed line in FIG. 6 indicates a change in temperatures of the supporting drum 18 that does not include the sealing member 45.

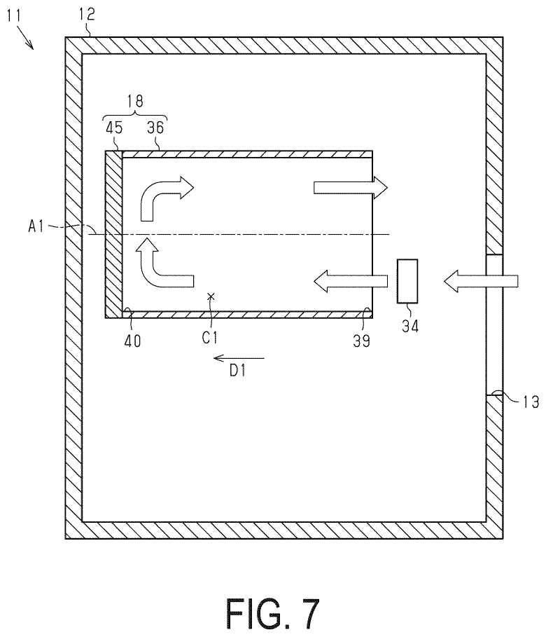

As illustrated in FIG. 7, in the supporting drum 18, air is delivered from the air blowing unit 34 through a portion of the first opening 39 that is disposed lower than the rotary axis A1. In the supporting drum 18, air is delivered from the air blowing unit 34 toward a space of the internal space C1 that is disposed lower than the rotary axis A1. With this configuration, air effectively flows in the internal space C1. In FIG. 7, the outline arrow indicates a flow of air. Air delivered to the internal space C1 is heated within the supporting drum 18. When heated, air is more likely to ascend. This makes air more likely to flow out through a portion of the first opening 39 that is disposed higher than the rotary axis A1. Thus, as the air blowing unit 34 delivers air toward a space of the internal space C1 that is disposed lower than the rotary axis A1, air smoothly flows into and flows out of the internal space C1. In addition, as the air blowing unit 34 delivers air toward a space of the internal space C1 that is disposed lower than the rotary axis A1, the printing unit 30 is less likely to be affected by the wind.

### Operation and Effect of Embodiment

Next, operation and effect of the embodiment described above will be described.
(1) The sealing member 45 is attached to the rotating body 36 so as to close the second opening 40. The air blowing unit 34 delivers air to the inside of the rotating body 36 from the first opening 39 toward the second opening 40. With the configuration described above, air delivered by the air blowing unit 34 stays within the supporting drum 18. This makes it possible to improve the cooling efficiency of the supporting drum 18. This reduces a possibility that the supporting drum 18 has a high temperature.
(2) The sealing member 45 includes a round plate. With the configuration described above, it is possible to effectively close the second opening 40 by the sealing member 45.
(3) The coupling portion 41 includes the plurality of ribs 42 extending from the shaft portion 37 toward the peripheral-surface portion 38. The ribs 42 divide the internal space C1 into a plurality of separated spaces C2. The rib 42 includes the through hole 43 opened therein, and the through hole 43 causes adjacent separated spaces C2 to communicate with each other. The configuration described above facilitates flowing of air within the internal space C1. This makes it possible to improve the cooling efficiency of the supporting drum 18.
(4) The inlet opening 13 is opened in the housing 12. With the configuration described above, the air blowing unit 34 delivers the outside air toward the internal space C1. This makes it possible to improve the cooling efficiency of the supporting drum 18.
(5) The air blowing unit 34 is disposed lower than the rotary axis A1, and delivers air toward a space of the internal space C1 that is disposed lower than the rotary axis A1. The air heated in the internal space C1 is more likely to ascend. Thus, the heated air is more likely to exit through a portion of the first opening 39 that is higher than the rotary axis A1. With the configuration described above, the air blowing unit 34 delivers air through a lower portion of the first opening 39, which enables air to smoothly flow in and flow out within the internal space C1. This makes it possible to improve the cooling efficiency of the supporting drum 18.

### Modification Example

The embodiment described above can be modified in the following manner, and be implemented. The embodiment described above and the following modifications can be combined for implementation to the extent in which the combination does not cause technical contradiction.

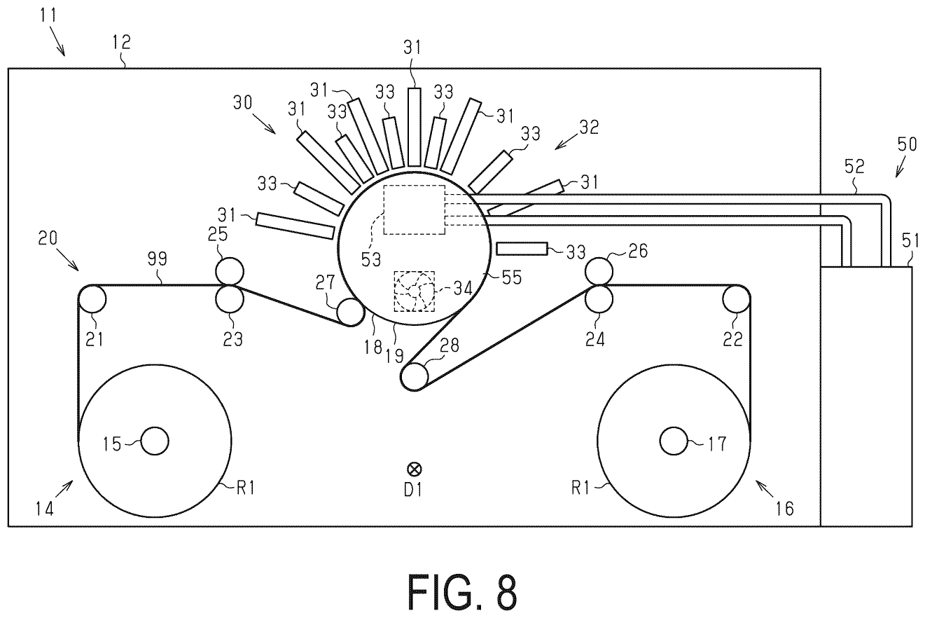

As illustrated in FIG. 8, the printing apparatus 11 may include a cooling unit 50. The cooling unit 50 is configured so as to cool the supporting drum 18. The cooling unit 50 is, for example, a chiller.

The cooling unit 50 includes a cooling section 51. The cooling section 51 may be disposed within the housing 12 or may be disposed outside of the housing 12. The cooling section 51 is configured to cool a refrigerant. The cooling section 51 cools the refrigerant through adiabatic compression and adiabatic expansion of a gas. Specifically, the cooling section 51 performs air cool or water cool of a gas that has been adiabatically compressed, and the gas is adiabatically expanded to generate a gas having a low temperature. The cooling section 51 cools the refrigerant using a gas having a low temperature. The gas is, for example, helium. The refrigerant is, for example, water.

The cooling unit 50 includes a refrigerant pipe 52. The refrigerant pipe 52 is a pipe through which the refrigerant flows. The refrigerant pipe 52 is coupled to the cooling section 51. The refrigerant pipe 52 is coupled to a heat exchanger 53, which will be described later. The refrigerant pipe 52 extends such that the refrigerant circulates through the cooling section 51 and the heat exchanger 53.

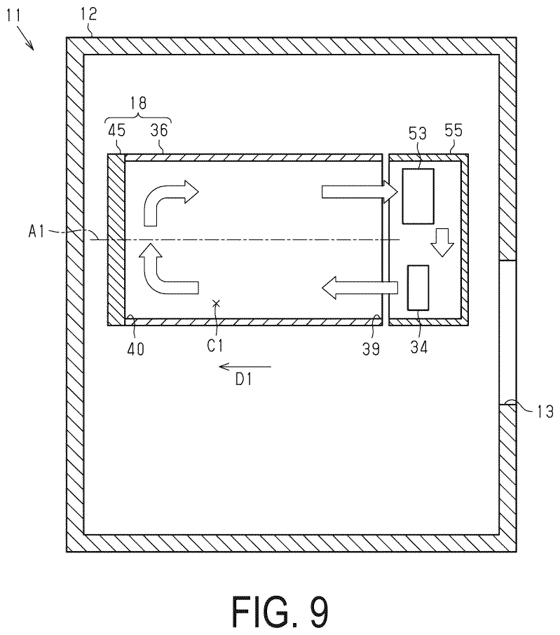

As illustrated in FIGS. 8 and 9, the cooling unit 50 includes the heat exchanger 53. The heat exchanger 53 is accommodated in the housing 12. The heat exchanger 53 is configured to perform thermal exchange using the refrigerant. The heat exchanger 53 is configured to perform thermal exchange with air existing in the internal space C1. The heat exchanger 53 uses the refrigerant supplied through the refrigerant pipe 52 to cool air existing in the supporting drum 18. This makes it possible to improve the cooling efficiency of the supporting drum 18.

The heat exchanger 53 is disposed so as to overlap with the supporting drum 18 when viewed from the shaft direction D1. The heat exchanger 53 is disposed so as to overlap with an upper portion of the first opening 39 when viewed from the shaft direction D1, for example. The heat exchanger 53 may be disposed so as to overlap with the air blowing unit 34 when viewed from the shaft direction D1. It is only necessary that the heat exchanger 53 is able to cool the supporting drum 18.

As illustrated in FIG. 9, the supporting drum 18 may include a lid member 55. The lid member 55 is configured to cover the first opening 39. The lid member 55 is attached to the rotating body 36, for example. The lid member 55 may rotate together with the rotating body 36 or may not rotate. The lid member 55 may cover the first opening 39 so as to closely seal the internal space C1, or may cover the first opening 39 to the extent in which air is able to come in from the outside of the supporting drum 18 or go out to the outside of the supporting drum 18. The lid member 55 covers the air blowing unit 34 and the heat exchanger 53. In this case, the air blowing unit 34 is disposed between the lid member 55 and the rotating body 36. The heat exchanger 53 is disposed between the lid member 55 and the rotating body 36. Air existing within the internal space C1 is directly cooled by the heat exchanger 53.

With the lid member 55 covering the first opening 39, air delivered by the air blowing unit 34 circulates within the internal space C1. With the lid member 55 covering the first opening 39, it is possible to improve the airtightness of the internal space C1. This makes it possible to improve the efficiency of cooling the air by the heat exchanger 53 within the internal space C1.

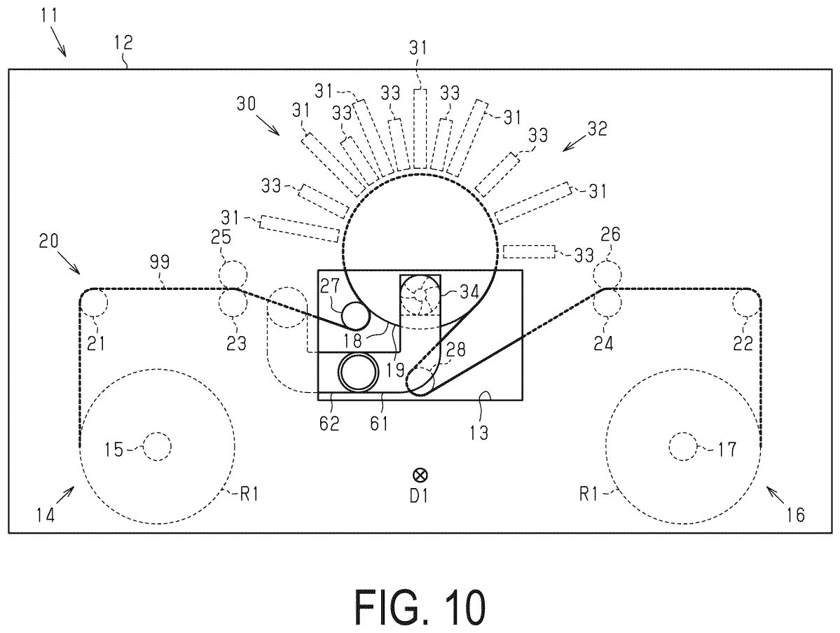

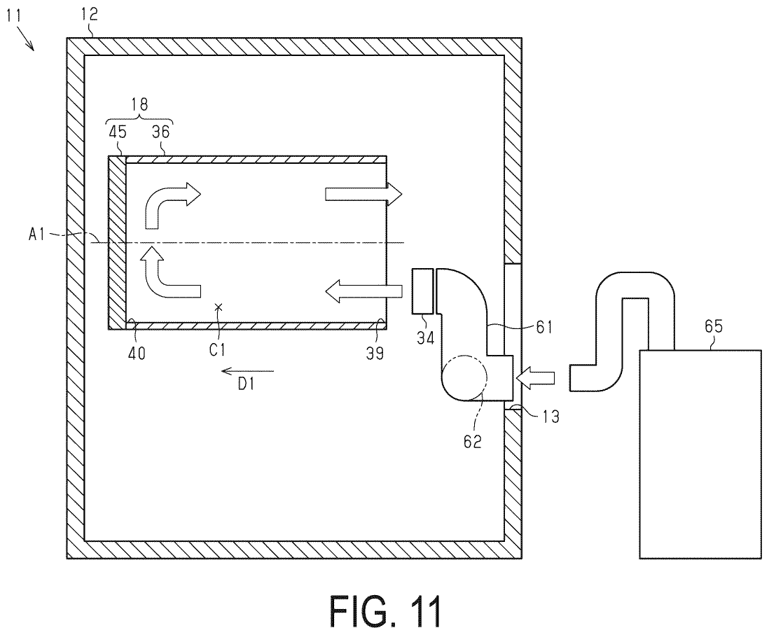

As illustrated in FIGS. 10 and 11, the printing apparatus 11 may include a cooling flow path 61. The cooling flow path 61 is a flow path used to guide cold air to the air blowing unit 34. The cooling flow path 61 extends from the inlet opening 13 toward the air blowing unit 34. The cooling flow path 61 is, for example, a duct. In this modification example, the printing apparatus 11 is configured to receive cold air from the spot cooler 65. The printing apparatus 11 receives cold air from the inlet opening 13 and takes it into the housing 12. The cooling flow path 61 guides the cold air supplied from the spot cooler 65, to the air blowing unit 34. With this configuration, the air blowing unit 34 delivers the cold air to the internal space C1, which makes it possible to improve the cooling efficiency of the supporting drum 18.

The printing apparatus 11 may include a cold-air flow path 62. The cold-air flow path 62 is a flow path used to guide cold air to a portion of the medium 99 that is not yet looped around the supporting drum 18. The cold-air flow path 62 extends from the inlet opening 13. The cold-air flow path 62 extends toward a portion of the medium 99 that is disposed between the first transport roller 23 and the first supporting roller 27, for example. In one example, the cold-air flow path 62 extends so as to split from the cooling flow path 61. The cold-air flow path 62 may be a separate flow path provided independently of the cooling flow path 61.

The cold-air flow path 62 guides the cold air supplied from the spot cooler 65 to a portion of the medium 99 on which printing is not yet performed. With this configuration, a portion of the medium 99 on which printing is not yet performed is cooled. Since a portion of the medium 99 on which printing is not yet performed is cooled, it is possible to reduce a possibility that the supporting drum 18 has a high temperature.

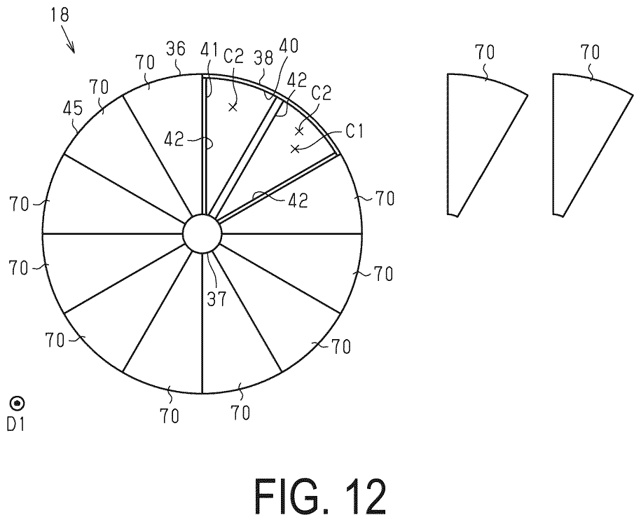

As illustrated in FIG. 12, the sealing member 45 may include a plurality of plate members 70. In this modification example, the sealing member 45 includes 12 plate members 70. The plate member 70 has a sector shape. The plate member 70 is attached to the rotating body 36 so as to close the separated space C2, for example. The 12 plate members 70 are attached to the rotating body 36 so as to each close separated spaces C2 divided into 12 pieces. With this configuration, the second opening 40 is closed.

### Technical Ideas

Below, description will be made of technical ideas and operational effects that are derived from the embodiment and modification examples described above.
(A) A printing apparatus includes: a supporting drum configured to support a medium looped therearound; a printing unit disposed so as to be opposed to the supporting drum and configured to discharge ultraviolet-light curable-type ink to the medium supported by the supporting drum; an emitting unit disposed so as to be opposed to the supporting drum and configured to emit ultraviolet light to the ink discharged to the medium; and an air blowing unit configured to deliver air to the supporting drum, in which the supporting drum includes a rotating body configured to rotate and also includes a sealing member attached to the rotating body, the rotating body includes a shaft portion, a peripheral-surface portion around which the medium is looped, and a coupling portion configured to couple the shaft portion and the peripheral-surface portion, the peripheral-surface portion defines a first opening and a second opening that open in a shaft direction, the sealing member is attached to the rotating body so as to close the second opening, and the air blowing unit delivers air to an inside of the rotating body from the first opening toward the second opening. With the configuration described above, air delivered by the air blowing unit stays within the supporting drum. This makes it possible to improve the cooling efficiency of the supporting drum. This reduces a possibility that the supporting drum has a high temperature.
(B) In the printing apparatus described above, the sealing member may include a round plate. With the configuration described above, it is possible to effectively close the second opening by the sealing member.
(C) The printing apparatus described above may be configured such that the sealing member includes a plurality of plate members and the plate members have a sector shape. With the configuration described above, it is possible to effectively close the second opening by the sealing member.
(D) The printing apparatus described above may be configured such that the coupling portion includes a plurality of ribs extending from the shaft portion toward the peripheral-surface portion, the ribs divide an internal space of the rotating body into a plurality of separated spaces, and the ribs include a through hole opened therein and causing the adjacent separated spaces to communicate with each other. With the configuration described above, air is more likely to flow within the internal space. This makes it possible to improve the cooling efficiency of the supporting drum.
(E) The printing apparatus described above may have a configuration in which the printing apparatus includes a cooling unit, the cooling unit includes a heat exchanger configured to perform thermal exchange using a refrigerant and a cooling section configured to cool the refrigerant, the supporting drum includes a lid member configured to cover the first opening, the heat exchanger is disposed between the lid member and the rotating body, and the air blowing unit is disposed between the lid member and the rotating body. With the configuration described above, air existing in the internal space is directly cooled by the heat exchanger. This makes it possible to improve the cooling efficiency of the supporting drum.
(F) The printing apparatus described above may be configured to include a housing, in which the housing includes an inlet opening opened therein and used by the air blowing unit to take in air from an outside. With the configuration described above, the air blowing unit delivers the outside air toward the internal space. This makes it possible to improve the cooling efficiency of the supporting drum.
(G) The printing apparatus described above may be configured such that the air blowing unit is disposed lower than a rotary axis of the supporting drum, and delivers air toward a space of an internal space of the supporting drum that is disposed lower than the rotary axis. The air heated in the internal space is more likely to ascend. Thus, the heated air is more likely to exit through a portion of the first opening that is higher than the rotary axis. With the configuration described above, the air blowing unit delivers air through a lower portion of the first opening that is disposed lower than the rotary axis, which enables the air to smoothly flow in and flow out within the internal space. This makes it possible to improve the cooling efficiency of the supporting drum.
(H) The printing apparatus described above may include a printing apparatus configured to receive cold air from a spot cooler, in which the printing apparatus includes a housing, an inlet opening configured to take the cold air into the housing is opened in the housing, the printing apparatus includes a cooling flow path configured to guide the cold air to the air blowing unit. With the configuration described above, the air blowing unit delivers the cold air made by the spot cooler to the internal space. This makes it possible to improve the cooling efficiency of the supporting drum.
(I) The printing apparatus described above may include a cold-air flow path configured to guide the cold air to a portion of the medium that is not yet looped around the supporting drum. The configuration described above makes it possible to cool a portion of the medium that is not yet looped around the supporting drum. This makes the medium less likely to have a high temperature. Thus, it is possible to reduce the possibility that the supporting drum has a high temperature.

What is claimed is:

1. A printing apparatus comprising:
a supporting drum configured to support a medium looped therearound;
a printing unit disposed so as to be opposed to the supporting drum and configured to discharge ultraviolet-light curable-type ink to the medium supported by the supporting drum;
an emitting unit disposed so as to be opposed to the supporting drum and configured to emit ultraviolet light to the ink discharged on the medium; and
an air blowing unit configured to deliver air to the supporting drum, wherein
the supporting drum includes:
a rotating body configured to rotate; and
a sealing member attached to the rotating body,
the rotating body includes:
a shaft portion;
a peripheral-surface portion around which the medium is looped; and
a coupling portion configured to couple the shaft portion and the peripheral-surface portion,
the peripheral-surface portion defines a first opening and a second opening that open in a shaft direction,
the sealing member is attached to the rotating body so as to close the second opening, and
the air blowing unit delivers air to an inside of the rotating body from the first opening toward the second opening.

2. The printing apparatus according to claim 1, wherein the sealing member includes a round plate.

3. The printing apparatus according to claim 1, wherein the sealing member includes a plurality of plate members and the plate members have a sector shape.

4. The printing apparatus according to claim 1, wherein
the coupling portion includes a plurality of ribs extending from the shaft portion toward the peripheral-surface portion,
the ribs divide an internal space of the rotating body into a plurality of separated spaces, and
the ribs include a through hole opened therein and causing the adjacent separated spaces to communicate with each other.

5. The printing apparatus according to claim 1 further comprising:
a cooling unit, wherein
the cooling unit includes:
a heat exchanger configured to perform thermal exchange using a refrigerant; and
a cooling section configured to cool the refrigerant,
the supporting drum includes a lid member configured to cover the first opening,
the heat exchanger is disposed between the lid member and the rotating body, and
the air blowing unit is disposed between the lid member and the rotating body.

6. The printing apparatus according to claim 1 further comprising a housing, wherein
the housing includes an inlet opening opened therein and used by the air blowing unit to take in air from an outside.

7. The printing apparatus according to claim 1, wherein
the air blowing unit is disposed lower than a rotary axis of the supporting drum, and delivers air toward a space of an internal space of the supporting drum that is disposed lower than the rotary axis.

8. The printing apparatus according to claim 1 that includes a printing apparatus configured to receive cold air from a spot cooler, wherein
the printing apparatus includes a housing,
an inlet opening configured to take the cold air into the housing is opened in the housing, and
the printing apparatus includes a cooling flow path configured to guide the cold air to the air blowing unit.

9. The printing apparatus according to claim 8 further comprising:
a cold-air flow path configured to guide the cold air to a portion of the medium that is not yet looped around the supporting drum.
